(19) United States
(12) Patent Application Publication
(10) Pub. No.: US 2006/0280548 A1
(43) Pub. Date: Dec. 14, 2006

(54) Toothbrush/toothpaste/dental floss dispenser compact unit

(76) Inventor: Lorne R. Sharpe, Winnipeg (CA)

Correspondence Address: Mr. Adrian D. Battison;Ade & Company Inc., 1795 Henderson Highway, P.O. Box 28006, Winnipeg, MB, R2G 4E9, CA

(21) Appl. No.: 11/442,358

(22) Filed: May 30, 2006

Related U.S. Application Data
(60) Provisional application No. 60/688,712, filed on Jun. 9, 2005.

(51) Int. Cl. A46B 17/04; A47L 13/22; B43K 5/06

(52) U.S. Cl. 401/269; 401/277; 401/175

(57) ABSTRACT

A compact toothbrush includes a toothpaste storing body and an actuator mechanism for dispensing toothpaste to the brush head, which is protected by a removable covering cap when not in use. The toothbrush includes a screw adaptor for attachment to a threaded end of a toothpaste tube, the screw adaptor being insertable into the end of the body and removable therefrom so as to allow the attachment of the toothpaste tube to the end of the body for filling with toothpaste. Rotation of a threaded actuator drives a plunger along the body to squeeze toothpaste stored within the body through a tube in the brush head. An end cap on the body attached to the threaded actuator includes elements thereon defining an angle of rotation of the end cap. Each defined angle of rotation defines a dose of toothpaste to be squeezed into the tube.

This application claims priority under 35 U.S.C. 119 from U.S. Provisional Application Ser. No. 60/688,712 filed Jun. 9, 2005.

This invention relates to a tooth brush with a dental floss and paste dispenser.

### BACKGROUND OF THE INVENTION

Portable toothbrushes which provide an integral paste dispenser are well known and many examples are available. Examples are shown in U.S. Pat. No. 6,481,910 (Yang) issued Nov. 19, 2002, in U.S. Pat. No. 5,918,996 (Coolbaugh) issued Jul. 6, 1999 and in U.S. Pat. No. 5,066,155 (English) issued Nov. 19, 1991. All of these disclose a toothbrush with a brush head at one end attached to a handle. The handle is hollow to provide a longitudinal enclosure for receiving paste. A plunger is mounted within the enclosure and moved longitudinally in the enclosure to squeeze the paste through a tube in the handle to the brush head. The open end of the enclosure at the plunger is closed by a cap so the rotation of the cap drives the plunger. The brush head is covered by a covering cap so that the resultant product is generally tubular.

Many arrangements of this type have been proposed but none are commercially available as it is believed they have significant disadvantages.

### SUMMARY OF THE INVENTION

It is one object of the invention to provide an improved toothbrush of this general type.

According to one aspect of the invention there is provided a toothbrush comprising:

a toothbrush head having a brush section and a neck section with a tube through the neck section for communication of paste to the brush section;

a hollow body for receiving paste with a threaded collar at one end for attachment to the neck section of the brush head;

a plunger located within the body on a threaded actuator by which rotation of the threaded actuator drives the plunger along the body to squeeze toothpaste stored within the body through the tube in the neck to the brush section;

a cap closing an open end of the body and attached to the threaded actuator;

a covering cap for covering the brush section and having a threaded coupling for connection to the body;

and a screw adaptor for attachment to a threaded end of a toothpaste tube, the screw adaptor being insertable into the end of the body and removable therefrom so as to allow the attachment of the toothpaste tube to the end of the body for filling with toothpaste.

Preferably the adaptor is threadedly engaged into the body.

Preferably the adaptor is removable from the body and storable within a receptacle in the cap.

Preferably the receptacle is shaped to receive a reel of floss.

Preferably the reel surrounds a cylindrical portion of the adaptor.

Preferably the receptacle is provided in an end cap portion of the cap member.

Preferably the end cap on the body attached to the threaded actuator includes elements thereon defining an angle of rotation of the end cap wherein each defined angle of rotation defines a dose of toothpaste to be squeezed into the tube.

Preferably the end cap is slidable axially against a spring so as to allow rotation through the angular rotation required for the single dose.

According to a second aspect of the invention there is provided a toothbrush comprising:

a toothbrush head having a brush section and a neck section with a tube through the neck section for communication of paste to the brush section;

a hollow body for receiving paste with a threaded collar at one end for attachment to the neck section of the brush head;

a plunger located within the body on a threaded actuator by which rotation of the threaded actuator drives the plunger along the body to squeeze toothpaste stored within the body through the tube in the neck to the brush section;

a cap closing an open end of the body and attached to the threaded actuator;

a covering cap for covering the brush section and having a threaded coupling for connection to the body;

wherein the end cap on the body attached to the threaded actuator includes elements thereon defining an angle of rotation of the end cap wherein each defined angle of rotation defines a dose of toothpaste to be squeezed into the tube.

The toothbrush shown and described herein includes the following features:

The toothbrush is always kept sterile because it is enclosed at all times except when filling or using.

In one embodiment, the angle and dose defining elements on the end cap attached to the threaded actuator comprises a lug, or locking pin cooperating with a notch, or hole receptacle, provided on the body. Toothpaste cannot be ejected out the toothbrush while not in use because the locking pin of the cap, or handle, and the body hole receptacle for the pin are spring pressure locked.

The exact amount of toothpaste for each tooth brushing is one rotation of the handle of the driver. This is regulated by the locking pin and hole receptacle for said pin. This is a spring loaded pressure enforced locking.

There would be a minimum of 20 turns of the handle of the driver which equal 20 brushings per filling of toothpaste or cartridge type refill.

The body of the toothbrush is filled either by screwing in the toothpaste tube or by inserting a refill type cartridge.

Prior to filling the body with toothpaste the toothbrush hole is cleared of toothpaste by the pulling out the actuator. This would cause the vacuum to suck the toothpaste out and give you a clean hole by the refilling so as not to force out what would be in the toothbrush hole of toothpaste.

You can never overfill this toothbrush with toothpaste as you can see the toothpaste after the body is filled start down the hole in the toothbrush so that you know when to stop.

The actuator and driver have left hand tap and die threads so that when the handle is turned you cannot accidentally open the cap from the body, as the cap and body have right hand tap and die threads. Instead, you would only be keeping the cap tight for safety.

This toothbrush unit can be filled and used even by a person working in the sewer without washing. You never even touch the toothpaste while filling or the toothbrush while using. This is a completely sanitary unit.

This toothbrush can be used, for example, by:
1) children at school;
2) armed forces in the field;
3) fishermen;
4) campers;
5) business men after a dinner out promoting; and
6) airplane passengers while in-flight.

A user's dental billings could drop immensely if this toothbrush is used regularly due to the fact it can be used anywhere.

The toothbrush provides a storage bin for dental floss.

Storage is provided for the adaptor, or toothpaste downsizer or filler insert, which is threaded to the body size and toothpaste tube size.

The adaptor or downsizer will be threaded to the cap for keeping the dental floss spool from coming out.

The dental floss will pass through the toothpaste tube sized threaded hole and a cutter will be on the flat surface of the adaptor.

There will be a small handle for the removal and putting back of this body-to-toothpaste threaded downsizer, which also serves as a floss retainer and dental floss cutter unit.

### BRIEF DESCRIPTION OF THE DRAWINGS

One embodiment of the invention will now be described in conjunction with the accompanying drawings in which:

FIG. 1 is an exploded view of a toothbrush according to the present invention with a secondary cap and a housing of a covering cap cross sectioned.

FIG. 2 is a side elevational view of the toothbrush head of the toothbrush of FIG. 1.

FIG. 3 is a side elevational view of the toothbrush of FIG. 1 showing the filling action with a body of the toothbrush partially cross sectioned.

FIG. 4 is an exploded view of an actuator mechanism of the toothbrush of FIG. 1.

FIG. 5 is a side elevational view of the assembled toothbrush.

FIG. 6 is a cross sectional view of the covering and secondary caps of the toothbrush showing mounting of a reel of floss.

FIG. 7 is a side elevational view of the toothbrush head.

FIG. 8 is a cross sectional view of the body unit with an adaptor for attachment to a toothpaste tube.

FIG. 9 is an assembled view of the actuator mechanism of FIG. 4 with a cap die thereof cross sectioned.

FIG. 10 is an end view of the die cap.

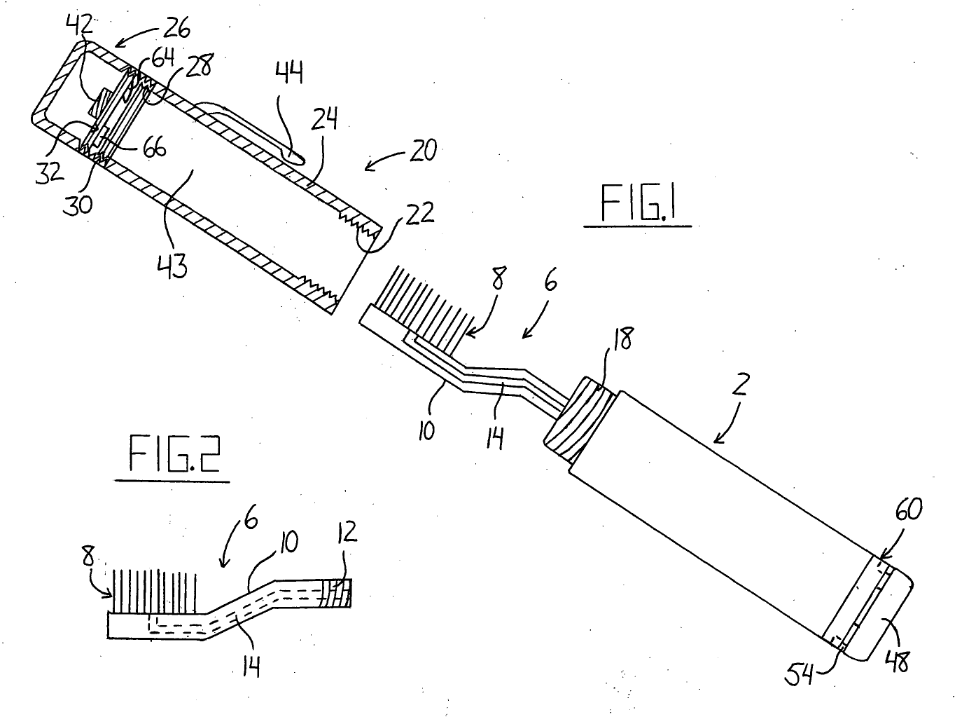

In the drawings like characters of reference indicate corresponding parts in the different figures.

### DETAILED DESCRIPTION

As shown in the figures, the toothbrush features a hollow body 2 for storing toothpaste, a brush head 6 extending from an end of the body and a covering cap 20 for removable engagement with the body to enclose the brush head 6. An actuator mechanism is provided on the body at an end opposite the brush head to facilitate dispensing of a predetermined dose of toothpaste from within the body to the brush head 6. The actuator mechanism is removable from the body to allow insertion of an adaptor in its place that can engage the body with a tube of toothpaste to facilitate controlled filling of the hollow body with toothpaste.

The body 2 includes a female threaded portion 4 for receiving the brush head 6 with a brush section 8 and a neck 10 so that the neck has a male screw threaded section 12 which threads into the female receptacle 4 on the end of the body. This communicates a tube 14 within the neck 10 to the interior 16 of the body 2 for receiving paste from the body. A larger male threaded section 18 on the body co-operates with a covering cap 20 which is a female threaded section 22 at the end of a cylindrical housing 24 which covers the brush section 8 when the covering cap 20 is in place on the male thread 18 of the body 2. At the end of the covering cap 20 is a receptacle with a second cap portion 26 which threads onto a male thread 28 on the end of the covering cap 20 with a female threaded section 30 at the end of the secondary cap 26. The secondary cap thus defines a hollow interior separated from the interior of the covering cap itself. This hollow interior receives the attachment piece, or adapter, 32 which is located in the end of the secondary cap 26 co-axial therewith. The attachment piece 32 has a male thread 34 at an outer diameter to match the end of the body 2 and a female thread at an inner diameter into which the male thread 36 of a toothpaste tube 38 can be inserted. While normally stored within the secondary cap 26, the adaptor 32 can be removed from its position within the secondary cap 26 and inserted when required into a female thread 40 at the end of the body 2. When inserted it defines a smaller sleeve for receiving the threaded end 36 of the toothpaste tube 38 which is threaded into the female thread in the adaptor 32. When the toothpaste is filled into the hollow interior 16 of the body 2, the adaptor 32 is removed and replaced within the secondary cap 26. A tubular section 42 of the adaptor 32 can be used to receive the interior diameter of a reel of floss 41 of a conventional nature readily commercially available.

Thus the secondary cap 26 received the adaptor 32 and the floss and acts as a storage therefore. On a flat surface of the adaptor 32 opposite the tubular section 42 and disposed radially outward from the threaded opening for receiving the threaded end 36 of the toothpaste tube are a cutter 64 and a handle 66. When a reel of floss 41 is supported about the tubular section 42, a free end of the floss can fed through the opening in the adapter 32. The adapter 32 is then threaded into the secondary cap 26 so that floss can be pulled through the opening in the adapter 32 and cut to a desired length by the cutter with the secondary cap 26 is removed from the covering cap 20. The handle 66 eases insertion and removal of the adapter 32 to and from the body 2 and secondary cap 26 by providing a gripping surface to actuate rotation of the adapter 32 with a finger. The interior 43 of the covering cap 26 itself can be used for storing water as a liquid to cover the toothbrush and also to act for rinsing. The cap has a pocket clip 44 which allows it to be attached onto the pocket of a user. The covering cap 20 is generally cylindrical which matches the exterior diameter of the cylindrical body 2.

The actuator for squeezing the toothpaste when filled is shown in FIGS. 4 and 9. This includes a threaded actuator which is connected to an end cap 48. The end cap 48 can be spring-actuated so that its use requires that it be pulled away from the body to release notches supported on the body. The notches are indicated at 50 and provide a pull-out safety lock so that the end cap 48 cannot be rotated when spring-biased into place against the body 2, due to engagement of lugs 54 with the notches 50. However when pulled back against the spring 52, lugs 54 on the end cap 48 or on the body 2 are released from co-operating notches 50 in the other element so that the end cap 48 can be rotated relative to the body through a turn of 180 degrees. This amount of rotation acts to drive a plunger 56 along the screw actuator 46 to squeeze the toothpaste along the body 2 and into the tube 14 in the brush head 6. The actuator includes the plunger actuator 56 with a lefthand thread which moves along the actuator or threaded rod, which is the driver 46, which also has a lefthand thread. The elements are held in place by a retaining clip 58. The screw-in cap die 60 closes the end of the body 2 by mating with the female threads 40 thereat and provides the locating notches 50 for co-operating with the lugs 54 of the end cap 48. There is provided a spacer washer 62 between the cap die 60 and the end cap member 48. The spring is shown at 52 which allows the movement to release the notches from the lugs.

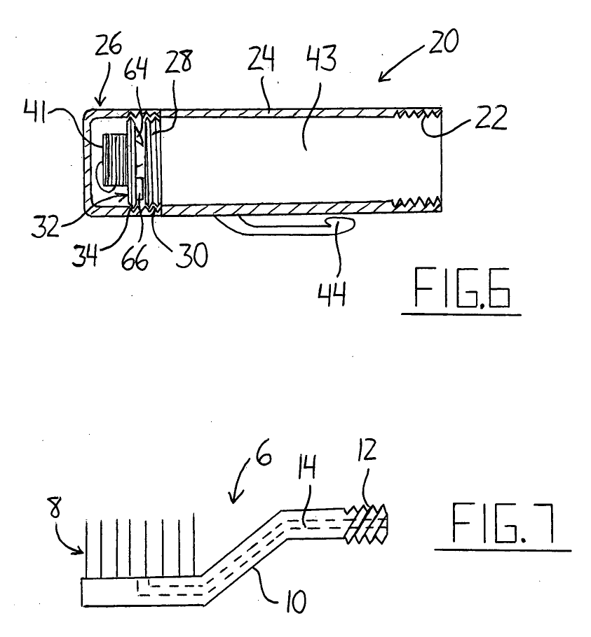

With the toothbrush in the fully assembled state of FIG. 5, the toothbrush can be carried, for example, in a pocket or purse without sacrificing sanitation as the brush head 6 is protected by the covering cap 20. With a reel of floss 41 supported within the secondary cap 26 by the adapter 32, floss is easily dispensable upon removal of the secondary cap from the covering cap 20 through simple rotation to disengage threads 28 and 30.

For brushing, a user simply removes the covering cap 20 from the body 2 through relative rotation to disengage threads 18 and 22 to expose the brush head 6. The end cap 48 is pulled axially away from the body 2 to disengage the lugs 54 from the notches 50 in the cap die 60. This pulling opposes a force provided by the spring 52 which pushes the retaining clip 58 further into the body interior 16 thereby biasing the end cap 48 toward the cap die 60. With the end cap so pulled out it is then rotated 180 degrees by the user, which due to engagement of the screw actuator 46 and plunger 56 causes the plunger to move along the screw actuator away from the end cap 48. With the end cap so rotated, the lugs 54 and notches 50 once again align and release of the end cap 48 returns it to its biased position due to the force of the spring 52. The new relative position of the plunger 56 on the screw actuator 46 causes it to force toothpaste from the body interior 16 into the tube 14 in the brush head 6 to the brush section 8. The opposite threading between the screw actuator and plunger and between the cap die and body ensures that rotation of the end cap to dispense toothpaste does not loosen the cap die and free the actuator from the body.

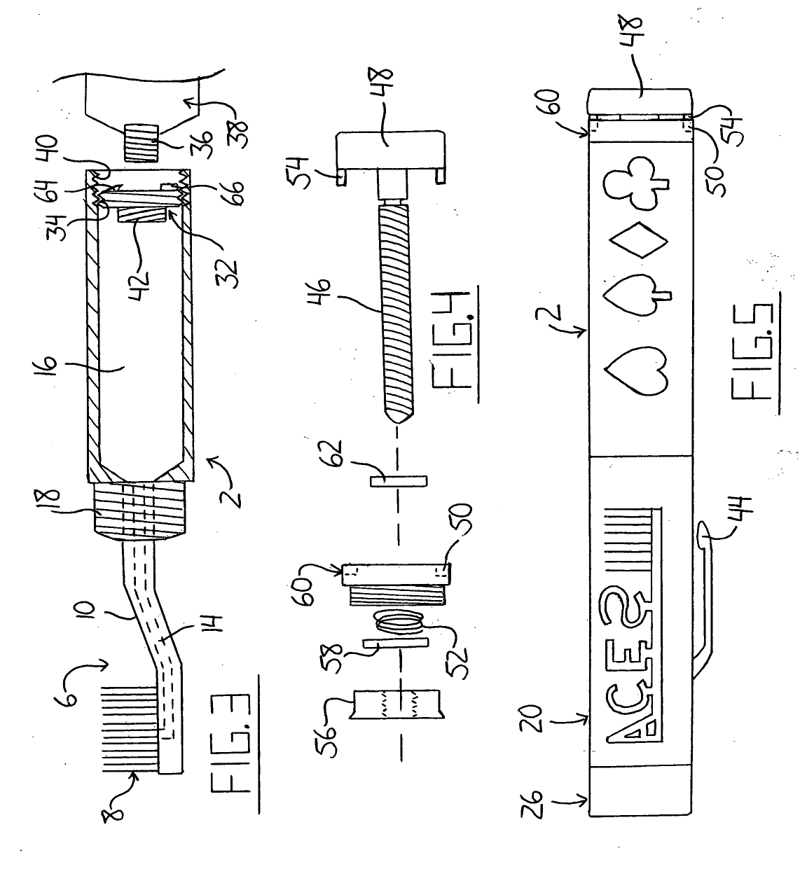

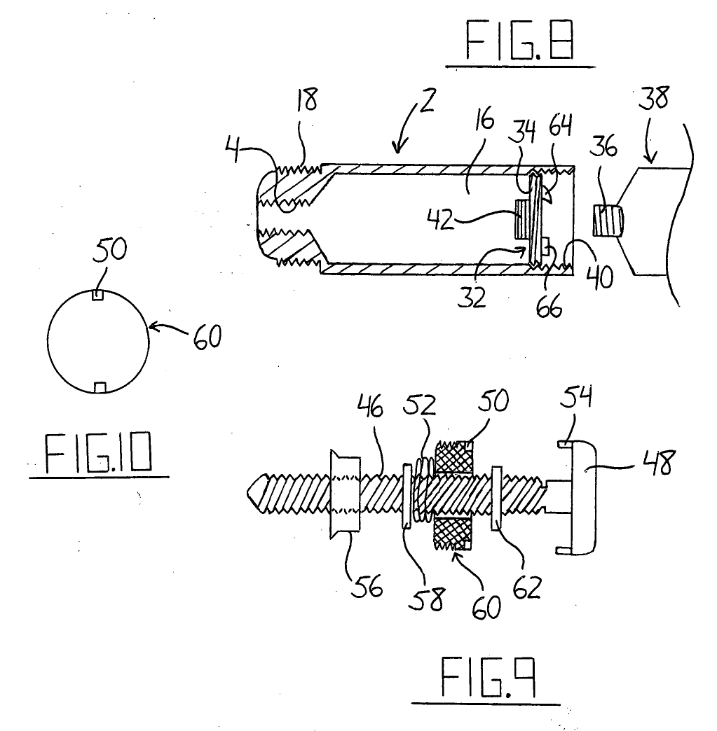

To refill the toothbrush with toothpaste, the actuator is removed from the body 2 by rotating the cap die 60 to disengage its male threads from the female threads 40 of the body and the adaptor 32 is removed from the secondary cap 26 through rotation by means of the handle 66 to disengage threads 30 and 34. The adaptor 32 is then threaded into the body in place of cap die 60, preferably first having removed any floss reel from the tubular section 42, as shown in FIGS. 3 and 8. The adaptor 32 acts as a downsizer to decrease the size of the opening at the end of the body 2 opposite the brush head 6 and is threaded to mate with the threaded end 36 of a toothpaste tube so as to provide a tight fit for controlled and mess-free filling. The toothpaste tube is engaged to the adapter so that squeezing the tube feeds toothpaste through the tubular section 42 of the adapter into the body interior 16. The adapter thereby serves two purposes in that it acts as a dental floss dispenser and a filling insert. Once the toothbrush is filled with toothpaste, the adapter 32 is removed from the body 2 and reinserted in the secondary cap 26 so that the actuator can be replaced in the body to render the toothbrush once again ready for use.

The mating lugs 54 and notches 50 act to provide a visual indication to the user as to how far the end cap 48 has been rotated in order to provide greater control over the amount of toothpaste dispensed as well as to provide a locking arrangement to prevent inadvertent dispensing of toothpaste to the brush head 6. While the lugs and notches are provided in diametrically opposed pairs on the end cap 48 and cap die 60 respectively, it should be appreciated that visual indicators or locking elements may be provided in alternate numbers and alternate spacing while performing the same function. For example, a single lug may be used with diametrically opposed notches to associate the same 180 degree rotation of the end cap with a single dose of toothpaste or a single lug and single notch arrangement may be used to associate a 360 degree rotation with a single dose. It should be appreciated that the linear displacement of the plunger along the screw actuator relative to the rotation of the end cap depends on the thread characteristics.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A toothbrush comprising:
a toothbrush head having a brush section and a neck section with a tube through the neck section for communication of paste to the brush section;
a hollow body for receiving paste with a threaded collar at one end for attachment to the neck section of the brush head;
a plunger located within the body on a threaded actuator by which rotation of the threaded actuator drives the plunger along the body to squeeze toothpaste stored within the body through the tube in the neck to the brush section;
a cap closing an open end of the body and attached to the threaded actuator;
a covering cap for covering the brush section and having a threaded coupling for connection to the body;
and a screw adaptor for attachment to a threaded end of a toothpaste tube, the screw adaptor being insertable into the end of the body and removable therefrom so as to allow the attachment of the toothpaste tube to the end of the body for filling with toothpaste.

2. The toothbrush according to claim 1 wherein the adaptor is threadedly engaged into the body.

3. The toothbrush according to claim 1 wherein the adaptor is removable from the body and storable within a receptacle in the cap.

4. The toothbrush according to claim 3 wherein the receptacle is shaped to receive a reel of floss.

5. The toothbrush according to claim 4 wherein the reel surrounds a cylindrical portion of the adaptor.

6. The toothbrush according to claim 5 wherein the receptacle is provided in an end cap portion of the cap member.

7. The toothbrush according to claim 1 wherein the end cap on the body attached to the threaded actuator includes elements thereon defining an angle of rotation of the end cap wherein each defined angle of rotation defines a dose of toothpaste to be squeezed into the tube.

8. The toothbrush according to claim 7 wherein the end cap is slidable axially against a spring so as to allow rotation through the angular rotation required for the single dose.

9. A toothbrush comprising:
a toothbrush head having a brush section and a neck section with a tube through the neck section for communication of paste to the brush section;
a hollow body for receiving paste with a threaded collar at one end for attachment to the neck section of the brush head;
a plunger located within the body on a threaded actuator by which rotation of the threaded actuator drives the plunger along the body to squeeze toothpaste stored within the body through the tube in the neck to the brush section;
a cap closing an open end of the body and attached to the threaded actuator;
a covering cap for covering the brush section and having a threaded coupling for connection to the body;
wherein the end cap on the body attached to the threaded actuator includes elements thereon defining an angle of rotation of the end cap wherein each defined angle of rotation defines a dose of toothpaste to be squeezed into the tube.

10. The toothbrush according to claim 9 wherein the end cap is slidable axially against a spring so as to allow rotation through the angular rotation required for the single dose.
